(19) United States
(12) Patent Application Publication
(10) Pub. No.: US 2023/0103115 A1
(43) Pub. Date: Mar. 30, 2023

(54) COMMUNICATION DEVICE AND METHOD FOR CRYPTOGRAPHICALLY SECURING COMMUNICATION

(71) Applicant: MERCEDES-BENZ GROUP AG, Stuttgart (DE)

(72) Inventors: Viktor FRIESEN, Karlsruhe (DE); Albert HELD, Neu-Ulm (DE); Viktor PAVLOVIC, Stuttgart (DE)

(21) Appl. No.: 17/801,861

(22) PCT Filed: Feb. 11, 2021
(86) PCT No.: PCT/EP2021/053260

§ 371 Date: Aug. 24, 2022

(30) Foreign Application Priority Data
Feb. 25, 2020 (DE) 10 2020 001 199.3

(51) Int. Cl. H04L 9/40; G06F 8/65; H04L 9/08

(52) U.S. Cl. CPC H04L 63/045; G06F 8/65; H04L 9/0852

(57) ABSTRACT

A communication device for a vehicle has a communication unit set up to establish a communication link between the vehicle and an external vehicle server and to exchange data in a cryptographically secured manner between the vehicle and the external vehicle server. The communication unit is further set up to be operated in a first or second mode. The modes differ in the type of cryptographic securing of the data. The communication unit has a secure hardware memory in which a binary value corresponding to the respective mode is stored.

### BACKGROUND AND SUMMARY OF THE INVENTION

Exemplary embodiments of the invention relate to a communication device for a vehicle, as well as a method for cryptographically securing the communication between a vehicle and a server external to the vehicle.

In general, modern vehicles, and in particular passenger cars and commercial vehicles, are part of a large vehicle ecosystem. A central part of this ecosystem is the so-called back-end. This is a server external to the vehicle that is usually operated by the vehicle manufacturer. The vehicles are connected to this external vehicle server via the internet. The communication between this back-end and the vehicles is typically secured by means of cryptographic processes, on the one hand in order to protect the privacy of the vehicle user and, on the other hand, to prevent any external interference in the data traffic, which could be used by hackers to attack the vehicles and manipulate important functions, in particular when data relating to vehicle control is transmitted.

Common practice here is the use of asymmetric keys or processes based on asymmetric cryptography. These are typically used in the form of so-called TLS (transport layer security), sometimes also IPSec (internet protocol security), which for their part use conventional asymmetric processes, such as RSA or ECC (elliptic curve cryptography) based on prime factorization.

Patent DE 10 2009 037 193 B4 describes a system and a method for carrying out an exchange of such an asymmetric key between a vehicle and an external vehicle server in order to operate the data connection in a correspondingly cryptographically secured manner, i.e., with encryption and/or authentication.

US 2012/0045055 A1 shows a communication device that enables two different cryptographic modes. It is possible to switch back and forth between these via a unit for switching the cryptographic modes. The disclosure makes no reference to a vehicle ecosystem.

US 2018/0217828 A1 shows the encrypted communication between a vehicle and an external vehicle server in itself.

For further prior art, reference can also be made to US 2011/0307633 A1, which deals with a tamper-proof documentation of unauthorized access to connection pins of an electronic controller.

The typically used asymmetric cryptographic processes, such as ECC or RSA, have the advantage here that they offer relatively secure protection with minimal expenditure according to the current state of the art. However, all these processes are based on cryptographic algorithms whose security is not considered to be robust compared to quantum computers. Due to the way they calculate, quantum computers are able to crack asymmetric cryptographic processes and decrypt secured data within a very short time. The cryptographic protection processes typically used for communication between the vehicle and the back-end, i.e., in particular for encryption and/or authentication, are then no longer secure. This so-called post-quantum threat was previously more of a theoretical threat, as quantum computers were still considered to be pure research instruments and could only be implemented with very high financial expenditure. In recent years, however, the development of quantum computers has gained significant momentum. A reliable forecast that sufficiently powerful quantum computers will not be commercially available on the market in the next ten years can therefore no longer be guaranteed nowadays.

Vehicles that come onto the market today will generally be on the road for 10 to 15 years. This means that the post-quantum threat, i.e., the potential possibility of using quantum computers that are easily or, in particular, commercially available at a later date to easily crack conventional cryptographic protection, is already relevant for vehicles to be supplied today. The communication of a communication device of the vehicle with the external server, which nowadays is secured via cryptographic protocols based mostly on RSA or ECC, would therefore no longer be secure with the occurrence of this post-quantum threat, so that secure communication from today’s perspective cannot be guaranteed throughout the entire expected operating life of the vehicles.

In order to cope with the post-quantum threat, asymmetric algorithms that are resistant to the post-quantum threat have been generally researched for several years. These are the approaches commonly referred to as post-quantum cryptography or PQC. However, these are not yet very mature, which means that they are not currently suitable for replacing conventional methods yet. This, therefore, means that today’s vehicles cannot yet be designed with post-quantum-capable cryptographic protection processes, as such techniques are not yet mature enough to allow a conclusive assessment of the expected security. In addition, there is no standardization as yet and the approaches have high resource requirements. A hasty switch to such quantum computer-resistant cryptographic processes is therefore neither sensible nor easily possible at the present time. If there were already a standardized PQC process that was considered sufficiently secure, it would also not make sense to implement such a process in today’s vehicle communication devices, as higher costs and high resource consumption would stand in the way of economic viability in the current vehicle ecosystem.

Furthermore, symmetric processes such as AES (advanced encryption standard) or hash processes such as SHA-512 (secure hash algorithm) or symmetric authentication processes such as HMAC (hashed message authentication code) are not fundamentally affected by the post-quantum threat according to current knowledge. According to current knowledge, the security of these processes would be halved by the occurrence of the post-quantum threat, so that a 128-bit key still provides 64-bit security depending on the availability of quantum computers. However, such an impairment can be relatively easily compensated for by increased key lengths.

Exemplary embodiments of the present invention is provide, despite this problem, a communication device for a vehicle and/or a method for securing communication between a vehicle and an external vehicle server, which, in the event of the occurrence of the post-quantum threat, continue to enable secured communication between the vehicle and the external vehicle server.

The communication device for a vehicle according to the invention comprises a communication unit set up to establish a communication link between the vehicle and an external vehicle server, i.e., ultimately between the vehicle and, for example, the back-end, and to exchange data in a cryptographically secured manner. Here, the communication device can either be used centrally in the vehicle and be operated by various control units, such as the telematics control unit or the head unit, or it can be integrated directly into the design of the control unit as part of such control units, which means that it may then be present multiple times in one vehicle.

According to the invention, the communication unit is further set up to be operated in a first or a second mode, wherein the modes differ in the type of cryptographic securing of the data, for example the type of authentication and/or encryption. The communication unit has a secure hardware memory in which a binary value corresponding to the mode, i.e., a flag, is stored. Using the flag of the communication unit stored in the secure hardware memory, it is determined whether the communication unit is operated in the first or the second mode, which differ with regard to the cryptographic securing of the data. Such a communication unit can already be implemented very easily today. It can be operated according to the current protection requirements in one mode with the usual and known keys thus far, and it can be used in the other mode with a different type of cryptographic securing In order to be able to meet future requirements.

In the communication device according to the invention, it is provided that the binary value in the secured hardware memory can only be changed once. In particular, a so-called write-once memory module (WOM) is provided for this purpose, which is stored with a value of zero, for example, and is incorporated in the communication unit when it is delivered. The first mode, i.e., in particular the pre-quantum mode, is then activated accordingly via this value zero. The communication unit of the vehicle can remain in this mode until the post-quantum threat has occurred due to external constraints, such as in particular the commercialization of quantum computers. The binary value can then be changed once, for example to the value one, which stands for the second mode and then secures the communication in particular against the post-quantum threat by using post-quantum-resistant cryptographic algorithms, for example symmetric processes with correspondingly large key lengths or post-quantum cryptographic processes that are then available at the time of switching, which could also easily be asymmetric again.

The binary value or the flag that triggers the switch from the first to the second mode can be changed in any way; in particular, these types should be secured sufficiently and, in particular, in a post-quantum-resistant manner. The change can be made, for example, as part of maintenance in the workshop or similar.

According to a very advantageous development of the communication device according to the invention, it is provided that conventional asymmetric processes are used for cryptographically securing the data in the first mode. This is, therefore, the mode provided for current operation, in accordance with the usual type thus far, which could also be referred to as pre-quantum mode. In the second mode, a corresponding cryptographic protection based on purely symmetric processes is then provided, which has a higher resistance to the post-quantum threat, or protection using post-quantum cryptography is provided. This second mode, which could also be referred to as post-quantum mode, thus provides for cryptographic protection that can be used as an alternative to the first mode, and in particular when the post-quantum threat has occurred as a result of the corresponding development and commercialization of quantum computers. Even then, it still provides secure protection.

Preferably, at least one secure interface for communication with the external vehicle server can be provided in the communication device or the communication unit, which is secured via symmetric cryptographic processes or a process of post-quantum cryptography. Such an interface can be used, for example, to exert a secure influence on the communication unit via remote access even after the post-quantum threat has occurred, for example to change, activate or deactivate functions and values, in particular as part of a software update or similar. It is also particularly advantageous that this secure interface can be used to change the binary value and thus to switch the mode via the external vehicle server.

It is advantageous and secure if, according to a development of the communication device, the binary value can be changed from the external vehicle server by means of a cryptographically secured command, via the conventional communication interface or preferably via the secured interface just described. This makes it possible to use the external vehicle server to switch the communication device or all communication devices of the corresponding manufacturer or design type from the first mode, in particular pre-quantum mode, to the second mode, in particular post-quantum mode. This method is relatively secure due to a cryptographically secured command, which requires identification and authentication of the sender and recipient, and which in itself is transmitted in encrypted form. For this purpose, the cryptographic protection of the command is configured in such a way that it uses - preferably exclusively - symmetric processes. According to current knowledge, such symmetric cryptographic processes can still be relatively securely used at the time of the occurrence of the post-quantum threat or after it has occurred, and a relatively high level of effort is required to break this protection, so that this type of cryptographic protection still offers the advantage of relatively high security for the provided case.

In accordance with an advantageous development of the communication device according to the invention, the cryptographic protection can preferably be provided via a secret stored in the communication unit. Such a secret, which can be imported into the communication unit during its manufacture, is a very secure option to secure switching between the modes in the corresponding case.

According to a further very favorable embodiment of this, different secrets can be stored for different functions of the protection. By means of such different secrets, it is possible, for example, to use a different secret, and possibly a different secured interface, to secure the secured interface if, on the one hand, the mode is switched or, on the other hand, functions that could no longer be adequately secured in post-quantum mode are switched off. Further secrets can be used for encryption, authentication, key exchange and/or securing a software update via the external server. These secrets can be based on 512-bit keys, for example, and should thus still offer a relatively high level of security even if the post-quantum threat has already occurred. Accordingly, in an advantageous embodiment of the communication device, it is provided that the communication unit is set up to perform an assignment of the different secrets to different functions. This can only be done as part of a software update when switching or after switching to the second mode. This achieves a further increase in security, since the secrets are, in principle, stored in the communication unit, but are only deployed immediately before they are used or as part of their use of a specific function, for example, securing the exchange of keys, securing a remote software update, securing authentication or similar. Since the decision as to which secret secures which function only has to be made when the software for switching to the second mode has been created, this achieves a further security advantage.

The method according to the invention for securing the communication between a vehicle and an external vehicle server uses a communication device for the communication, which can, for example, be designed in the manner described above, but does not have to be. The communication device establishes a communication link between the vehicle and the external vehicle server, i.e., for example a back-end, via a communication unit. According to the invention, the communication unit can be operated in two modes, wherein a switchover takes place between the first and the second mode via a binary value stored in a memory, which is changed to trigger the switchover. Similar to the communication device according to the above description, operation with two different modes is thus also possible here. According to a very advantageous development of the method according to the invention, the two modes can be used to implement data protection based on conventional asymmetric cryptography in the first mode and symmetric cryptographic protection or protection by means of post-quantum cryptography in the second mode, which in turn would be the post-quantum mode.

In the method according to the invention, it is also provided that the binary value can only be changed once, for which purpose, for example, the WOM module already mentioned above for the communication device can be used again.

The binary value can be changed in various manners and/or various ways, as already mentioned above. In the method according to the invention, it is also provided, comparable with the communication device according to the invention, that according to a particularly favorable and advantageous embodiment of the method, the changing of the binary value, and thus the switch to another operating mode, is triggered via a symmetrically secured message of the external vehicle server. This means that the risk of misuse or accidental switching is relatively low, and using the external vehicle server, the corresponding commands can be triggered centrally and ideally in the hands of the vehicle manufacturer, and software updates or similar can be installed.

In the method according to the invention, it is further provided in accordance with a particularly advantageous embodiment that, when switching to the second mode, functions and protocols that were used in the first mode are deactivated and/or replaced by functions and protocols suitable for the second mode. By deactivating or even deleting the corresponding functions and protocols for the first mode, space can be created on the one hand and, on the other hand, optimized functions for the second operating mode can be installed. In this way, it is possible to implement an efficient switch to the second mode without making the memory requirements of the communication unit correspondingly high in the supplied state.

In addition to the pure replacement of functions and protocols by counterparts adapted for the post-quantum mode, it is also provided according to an advantageous development of the method that services and applications, which cannot be sufficiently secured in the second mode by the modified cryptographic protection, are switched off. The applications and services, such as installed programs and similar, which can no longer be used in the second mode because, for example, it is not possible to have sufficient computing capacity to implement the cryptographic protection in the new way, can be switched off in this way to ensure that these functions are at least not operated in such a way that they can be compromised by third parties. In the course of maintaining security, the loss of individual functions is less serious here than if functions could, for example, be cracked by hackers and used for corresponding attacks on the vehicles.

A further favorable embodiment of the method according to the invention further provides that post-quantum cryptographic keys are only generated at all from secrets stored in the communication unit during its manufacture and a master key securely stored in the external vehicle server when switching to the second mode. The keys are therefore not stored for the entire period during which the communication device is working in the first operating mode, but only a corresponding secret is stored securely, for example in a hardware security module. A master key securely stored in the external server can then, for example together with an identifier of the communication unit or of the vehicle equipped with it, generate a key which is then able to meet the highest security requirements.

A further advantageous embodiment of the method can also provide that new functions, protocols and/or mechanisms for cryptographic protection are imported via a software update at least when switching to the second mode, wherein the transmission of the software update is protected via symmetric cryptographic protection or protected by means of post-quantum cryptography (PQC). This means that PQC processes for the future cryptographic protection of the transmission of data that are not yet available today can be transmitted and implemented, for example, via a transmission of a software update that is protected with conventional symmetric processes at a given time.

Further very advantageous embodiments of the communication device according to the invention as well as of the method for securing the communication between a vehicle and an external vehicle server, though, for example, not necessarily with such a communication device, also result from the exemplary embodiments which are described in more detail below with reference to the figures.

### BRIEF DESCRIPTION OF THE DRAWING FIGURES

Here are shown:

FIG. 1 a schematic scenario explaining the invention;

FIG. 2 a communication device in a possible configuration according to the invention; and

FIG. 3 a fleet of vehicles with such communication devices and an external vehicle server.

### DETAILED DESCRIPTION

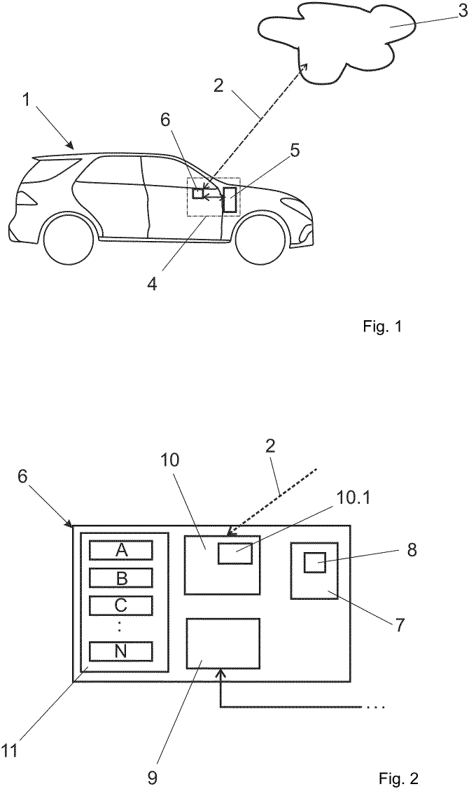

In the illustration of FIG. 1, a vehicle 1 can be seen communicating via a secure communication link 2 with an external vehicle server 3, which is shown here as a cloud. This external vehicle server can, in particular, be a back-end of the vehicle manufacturer. For this purpose, the vehicle has a communication device 4 which, for example, communicates with control units 5 of the vehicle 1, such as a telematics control unit and/or a head unit, or is also integrated into their design. In any case, the configuration comprises a communication unit 6, via which the secure communication between the vehicle 1 and the external vehicle server 3 takes place. Each control unit can individually use its own communication device, or several control units together can use a central communication device 4.

The communication device 4 or its communication unit 6 allows operation in two different operating modes, each of which works with different cryptographic protection. The first mode, which will still be set when the vehicle 1 is supplied at the current time, allows communication via conventional standardized processes, which are typically asymmetric, in particular via TLS or possibly also IPSec using RSA or ECC. This first mode can also be referred to as pre-quantum mode because the protection it offers can be classified as secure at the current time. However, if quantum computers become generally accessible and, in particular, market-ready, then such protection mechanisms, which are based on RSA or ECC, for example, can be cracked very easily and do not offer sufficient protection for security-related data transmitted between the server 2 and the vehicle 1. The communication device 4 provides a second mode for this purpose, which can also be referred to as the post-quantum mode. This is activated in particular when quantum computers are correspondingly available and thus the situation commonly referred to as the post-quantum threat has occurred.

In this situation of the existing post-quantum threat, i.e., when quantum computers are more or less freely available to break conventional asymmetric cryptographic processes, alternative cryptographic processes are required that can withstand this threat. It is then possible to switch from the previously used conventional asymmetric cryptography, for example, to a previously known conventional symmetric cryptography. According to current knowledge, this switch to AES, SHA-512, or HMAC, for example, is secure insofar as the security of the key is only halved by the quantum computer. However, this can easily be compensated for by longer keys, for example keys with 256 or, in particular, 512 bits, which then still offer a security of 128 or 256 bits respectively. Alternatively, it is also possible to switch from conventional asymmetric cryptography in the first mode to post-quantum cryptography (PQC) when switching to the second mode. Such post-quantum cryptographic processes are currently under development, but have not yet been standardized and their security cannot yet be definitively assessed. However, such processes can also be used because the connection of the communication device 4 to the external vehicle server 3 means that it can also be provided with corresponding software updates in order to correspondingly implement cryptographic processes arising in the future that work in accordance with the PQC process via software updates.

In order to be able to now implement the switch as simply and efficiently as possible, in particular without being able to implement the replacement of control units 5 or the communication device 4, a binary value, which is indicated here by the box 8, is stored in the communication unit 6 in a secure hardware memory 7, as can be seen in the schematic representation of the communication unit 6 in FIG. 2. This binary value 8, which can also be referred to as the post-quantum flag, indicates whether the communication unit 4 is in the first pre-quantum mode, which is the current supplied state of the communication device 4, or whether it has changed its value and the communication unit 6 is in post-quantum mode, i.e., in the mode which is to be activated after the post-quantum threat has occurred. It is preferably the case here that this binary value can only change its value once, from the first mode to the second mode. This can be implemented in terms of hardware, for example, with the aid of a write-once memory (WOM) module, so that the protected hardware memory 7 is intended in particular to be such a WOM module.

The communication unit 6 has various interfaces, for example an interface 9 to the control units 5 or the communication interface 10 for the secured data transmission 2. This interface 10 or, in particular, a part of this interface 10 functions via post-quantum-resistant processes as a secure interface 10.1, which can be used by the external vehicle server 3 if required, e.g., to switch the binary value 8 from the first to the second mode, i.e., to switch the communication unit 6 to post-quantum mode. This secured interface 10.1 can be protected here with the aid of symmetric cryptographic processes already known today and considered relatively secure against a post-quantum threat. Examples of this could be AES-256, SHA-512, HMAC-256. This or a further post-quantum-resistant secured interface 10.1 can also be used by the external vehicle server 3, if necessary, to correspondingly switch off services or applications in the communication unit 6 or in the control units 5 connected to it or to replace them with more suitable functions, services and applications as part of a remote software update which runs via the correspondingly secured interface 10.1, which functions, services and applications are optimized, if necessary, with respect to the protection mechanisms used in the second operating mode for cryptographic protection.

Accordingly, in order to achieve a secure exchange of data in the event of the switch, it can be correspondingly provided that individual secrets A, B, C ... N were securely imported and stored in the devices when the communication unit 6 was made. This can be implemented, for example, by using so-called hardware security modules 11, i.e., a specially secured memory or memory area. It should now be possible to use these secrets A, B, C ... N exclusively in the second mode, i.e., in post-quantum mode. Separate keys of sufficient length are to be imported for each cryptomechanism to be used in post-quantum mode. The individual secrets A, B, C ... N are therefore assigned to different functions or are assigned to such as part of a software update during or after the switch to the second mode. For example, a 512-bit secret can be provided to protect the secured interface 10.1 for mode switching. A further 512-bit secret can be provided to protect a further secured remote interface or a further interface provided in the interface module in parallel with the interface 10.1 just mentioned for shutting down applications that are not sufficiently secured in post-quantum mode, i.e., applications that can no longer be secured or protected with sufficient security in the second mode, for example due to the available resources. Further secrets can also be provided, for example in the form of 512-bit secrets, for encryption, authentication, key exchange, and for securing a software update, in particular via a corresponding remote interface.

Thus, after switching the communication unit 6 to post-quantum mode by changing the binary value 8, the communication unit 6 is now operated in post-quantum mode in such a way that the data of the communication link 2 is secured via a new or different type of cryptography.

A first alternative of the configuration of the communication unit 6 and the associated method could provide for the individual data to be stored twice. This means a prophylactic implementation and provision of a complete set of post-quantum-resistant functions and protocols in addition to the pre-quantum functions and protocols. The post-quantum-resistant functions and protocols can then be used immediately in the event of a switch from the first to the second mode. The advantage of this alternative is that, in the event of switching to post-quantum mode, secure communication between the vehicle 1 and the external vehicle server 3 is immediately possible. However, since there is no generally standardized PQC procedure available at the time of application, the only option currently available for this alternative is the use of symmetric cryptography, which, according to current knowledge, guarantees sufficient protection even in post-quantum mode after the post-quantum threat has occurred, particularly if the selected key length is correspondingly large.

The second alternative is that the cryptographic processes are only updated by a software update, for example in the course of switching the communication unit 6 from the first to the second mode. The exact type and use of the key material stored in the communication unit 6 or the secrets A, B, C ... N on which it is based is therefore only defined by a software update, in particular a remote software update by the external vehicle server 6 and the software to be imported in the course of this. This alternative has the advantage that memory space can be saved, since only one type of communication protection needs to be present in each of the two modes. Furthermore, it is the case that today it is not yet necessary to determine which process is to be used at all using the pre-stored secrets A, B, C ... N in the event of switching to post-quantum mode. In this way, knowledge gained between the delivery of the communication unit 6 or the vehicle 1 equipped with it and the occurrence of the post-quantum threat can be incorporated into the decision as to how the encryption is to be implemented in the second mode. In particular, it may be possible in this way to switch from the conventional asymmetric process to a correspondingly asymmetric PQC process if both the computing and storage capacities in the communication unit 6 are sufficient for this and the previously stored secrets A, B, C ... N are of a sufficient length to derive PQC keys from them, if shared secrets are required at all to derive or negotiate asymmetric PQC keys, which is not yet known.

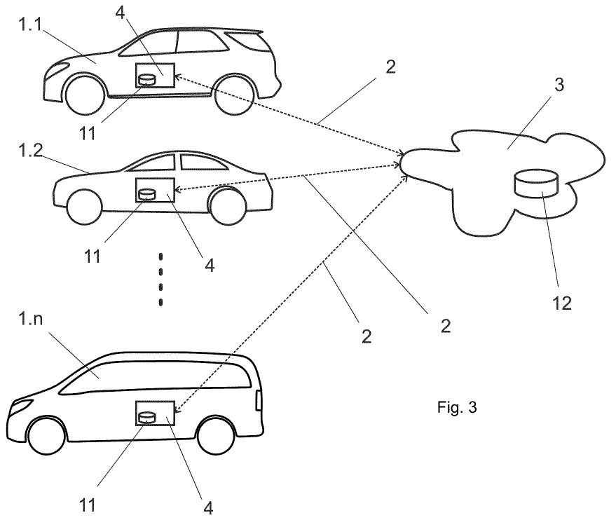

In addition to keeping the secrets A, B, C ... N in the hardware security module 11 of the communication unit 6, these individual secrets must also be stored securely in the external vehicle server and must be able to be assigned to the corresponding devices or vehicles, for example via a unique device ID for the respective communication unit 6 or communication device 4, or the vehicle 1 equipped with it. Alternatively, the individual secrets could also be derived, among other things, from the device ID with the aid of post-quantum secure processes, such as symmetric processes and a master key. Suitable key derivation functions (KDF) can be used for this purpose. The illustration in FIG. 3 shows this situation schematically. In the area of the external vehicle server 3 there is a database 12 in which a master key of sufficient length is securely stored. By communicating with individual vehicles 1.1, 1.2, ... 1.n or the communication devices 4 located therein, it is now possible to use a device ID of the respective communication device 4 for the respective vehicle 1.1, 1.2, ... 1.n in order to be able to carry out the corresponding key derivations via the master key.

As already mentioned, after switching to the second mode, all services and applications as well as functions that cannot or cannot sufficiently be protected by the new cryptographic protection, for example due to a lack of resources, are switched off accordingly by the external vehicle server via the secured interface 10.1, or are switched off or deactivated in the control units 5 connected to the communication unit 6 via the interface 9.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-15. (canceled)

16. A communication device for a vehicle, the communication device comprising:
a communication unit comprising a secure hardware memory and configured to establish a communication link between the vehicle and an external vehicle server;
exchange data in a cryptographically secured manner between the vehicle and the external vehicle server; and
be operated in a first or second mode,
wherein the first and second modes differ in a type of cryptographic securing of the data,
wherein a binary value corresponding to one of the first and second modes in which the communication unit is currently being operated is stored in the secure hardware memory, and
wherein the binary value in the secured hardware memory is only changeable once.

17. The communication device of claim 16, wherein the first mode comprises asymmetric cryptographic protection of the data, and the second mode comprises symmetric cryptographic protection or protection by post-quantum cryptography.

18. The communication device of claim 16, wherein the secured hardware memory is a write-once memory.

19. The communication device of claim 16, wherein the communication unit comprises at least one secure interface configured for communication with the external vehicle server, wherein the at least one secure interface is secured via symmetric encryption or a process of post-quantum cryptography.

20. The communication device of claim 16, wherein the binary value is changeable from the external vehicle server by a cryptographically secured command, wherein protection of the command is configured via a symmetric cryptographic process.

21. The communication device of claim 20, wherein the protection and encryption of the cryptographically secured command employs at least one secret stored in the communication unit.

22. The communication device of claim 21, wherein different secrets are stored in the communication unit for different functions of the cryptographic protection.

23. The communication device of claim 22, wherein the communication unit is configured to assign the different secrets to different functions only as part of a software update during or after a switch from the first mode to the second mode.

24. A method for securing communication between a vehicle and an external vehicle server, the method comprising:
establishing, by a communication unit of the vehicle, a communication link between the vehicle and the external vehicle server;
operating the communication unit in a first one of two modes during communications over the communication link; and
switching the communication unit from operating in the first one of the two modes to operating in a second one of the two modes based on a binary value stored in a secured memory of the communication unit, wherein the binary value is only changeable once.

25. The method of claim 24, wherein the first mode comprises asymmetric cryptographic protection and the second mode comprises symmetric cryptographic protection or protection by post-quantum cryptography.

26. The method of claim 24, wherein changing of the binary value and the switching from the first one of the two modes to the second one of the two modes is triggered via a symmetrically secured message of the external vehicle server.

27. The method of claim 24, wherein when switching from the first one of the two modes to the second one of the two modes, functions and protocols used in the first one of the two modes are deactivated or replaced by functions and protocols for the second one of the two modes.

28. The method of claim 24, further comprising:
switching off services and applications that cannot be sufficiently secured in the second one of the two modes.

29. The method of claim 24, further comprising:
generating, when switching from the first one of the two modes to the second one of the two modes, post-quantum cryptographic keys from secrets stored in the communication unit during manufacture of the communication unit and a master key securely stored in the external vehicle server.

30. The method of claim 24, wherein new functions, protocols, or mechanisms for cryptographic protection are imported via a software update at least when switching to the second one of the two modes, wherein transmission of the software update is protected via symmetric cryptographic protection or protected by post-quantum cryptography.
